(19) United States
(12) Patent Application Publication
(10) Pub. No.: US 2013/0195736 A1
(43) Pub. Date: Aug. 1, 2013

(54) HEAT EXCHANGER REFORMER

(71) Applicant: DELPHI TECHNOLOGIES, INC., Troy, MI (US)

(72) Inventor: BERNARD A. FISCHER, HONEOYE FALLS, NY (US)

(73) Assignee: DELPHI TECHNOLOGIES, INC., TROY, MI (US)

(21) Appl. No.: 13/711,834

(22) Filed: Dec. 12, 2012

Related U.S. Application Data
(63) Continuation-in-part of application No. 13/363,760, filed on Feb. 1, 2012.

(51) Int. Cl. C01B 3/26

(52) U.S. Cl. CPC C01B 3/26
USPC 422/625; 422/198

(57) ABSTRACT

A catalytic reformer assembly includes a heated medium flow path for a first medium and a reforming flow path for a second medium. A catalyst substrate is located within the reforming flow path and supports a catalyst. A heat exchanger is disposed within the heated medium flow path for transferring heat from the heated medium flow path to the catalyst substrate.

### CROSS-REFERENCE TO RELATED APPLICATIONS

This application is a continuation-in-part of U.S. patent application Ser. No. 13/363,760 filed on Feb. 1, 2012, the teaching of which is incorporated herein by reference in its entirety.

### GOVERNMENT-SPONSORED STATEMENT

This invention was made with government support under contract DE-EE0000478 awarded by the Department of Energy. The government has certain rights in the invention.

### TECHNICAL FIELD OF INVENTION

The present invention relates to a fuel reformer assembly for generating hydrogen-containing reformate from hydrocarbons using a catalytic conversion process; more particularly to such a fuel reformer assembly to which heat is added in order to facilitate the catalytic conversion process; and still even more particularly to such a fuel reformer assembly which includes multiple catalysts arranged in series.

### BACKGROUND OF INVENTION

Reformer assemblies are used for generating hydrogen-containing reformate from hydrocarbons. In such a reformer assembly, a feedstream comprising air, hydrocarbon fuel, steam, anode exhaust gas, and/or system exhaust gas is converted by a catalyst into a hydrogen-rich reformate stream. In a typical reforming process, the hydrocarbon fuel is percolated with oxygen and/or steam through a catalyst bed or beds contained within one or more reactor tubes mounted in a reformer vessel. The catalytic conversion process is typically carried out at elevated catalyst temperatures in the range of about 600° C. to 1100° C.

It may be desirable to utilize multiple catalysts to convert the feedstream into the reformate stream. Some of the catalysts may require heat to be added to support a reaction while other catalysts may operate best when heat is not added or when a reduced level of heat is added. Furthermore, there are some areas of the reformer assembly, for example the point of entry of the feedstream, the may operate best at temperatures that are lower than some of the catalysts.

What is needed in the art is a compact reformer arrangement that provides sufficient heat transfer to areas of the reformer where heat augmentation is desired while minimizing heat transfer to areas where heat augmentation is not desired. What is also needed is a reformer that manages thermal needs in use.

### SUMMARY OF THE INVENTION

Briefly described, a catalytic reformer assembly includes a heated medium flow path for a first medium and a reforming flow path for a second medium. A catalyst substrate is located within the reforming flow path and supports a first catalyst. A heat exchanger is disposed within the heated medium flow path for transferring heat from the first flow path to the catalyst substrate.

### BRIEF DESCRIPTION OF DRAWINGS

This invention will be further described with reference to the accompanying drawings in which:

FIG. 1 is a schematic longitudinal cross-sectional view of a catalytic hydrocarbon reformer assembly in accordance with the invention;

FIG. 2 is an exploded isometric view of the catalytic hydrocarbon reformer assembly of FIG. 1;

FIG. 3 is an exploded isometric view of a first component of the catalytic hydrocarbon reformer assembly of FIGS. 1 and 2;

FIG. 4 is an exploded isometric view of a second component of the catalytic hydrocarbon reformer assembly of FIGS. 1 and 2; and

FIG. 5 is an exploded isometric view of a third component of the catalytic hydrocarbon reformer assembly of FIGS. 1 and 2.

### DETAILED DESCRIPTION OF INVENTION

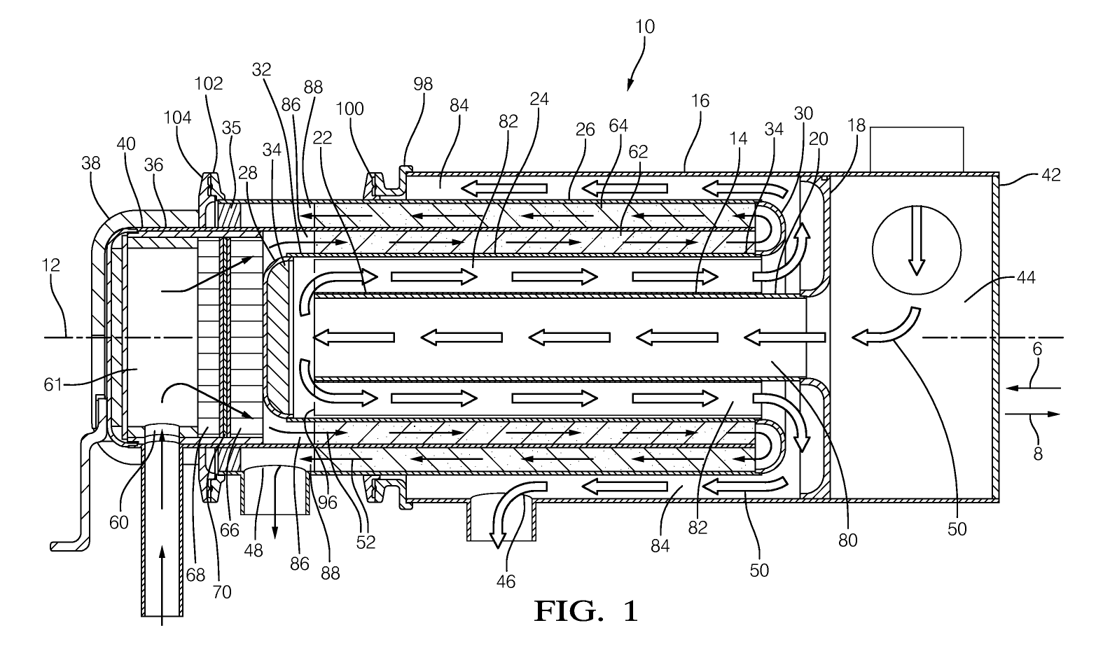

Referring to FIG. 1, a catalytic reformer assembly 10 having a longitudinal axis 12 comprises walls that define a first medium flow path 50, i.e. a heated medium flow path indicated by open arrows, for a first medium, and a second medium flow path 52, i.e. a reforming flow path indicated by solid arrows, for a second medium. The first medium may be a hot fluid stream and the second medium may be a feedstream that is to be heated by heat transfer from the first medium. The first medium flow path 50 includes a central flow channel 80 configured to direct flow in a first axial direction 6. The first medium flow path 50 further includes a first annular flow channel 82 radially surrounding at least a portion of the central flow channel 80 and configured to direct flow from the exit of the central flow channel 80 in a second axial direction 8 opposite the first axial direction 6. The first medium flow path 50 further includes a second annular flow channel 84 radially surrounding at least a portion of the first annular flow channel 82 and configured to direct flow from the exit of the first annular flow channel 82 in the first axial direction 6.

Still referring to FIG. 1, the second medium flow path 52 comprises a third annular flow channel 86 and a fourth annular flow channel 88 each disposed radially between the first annular flow channel 82 and the second annular flow channel 84, with the third annular flow channel 86 configured to direct flow in the second axial direction 8 and the fourth annular flow channel 88 configured to direct flow in the first axial direction 6. The first medium flow path 50 is fluidly isolated from the second medium flow path 52 within the reformer assembly 10.

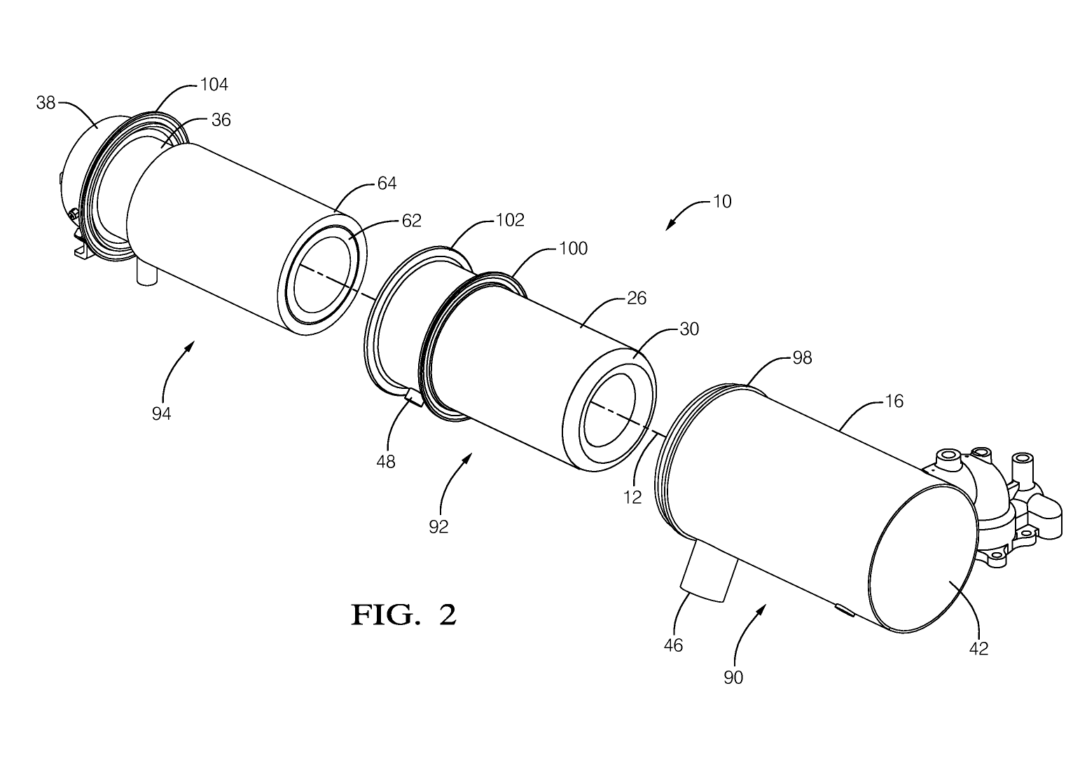

In an exemplary embodiment of the invention, the reformer assembly 10 may comprise subassemblies as shown in FIG. 2. These subassemblies may include a combustor assembly 90, a reactor assembly 92, and a feedstream delivery unit (FDU) assembly 94. The construction and interaction of the combustor assembly 90, reactor assembly 92, and FDU assembly 94 will be described in detail in the paragraphs that follow.

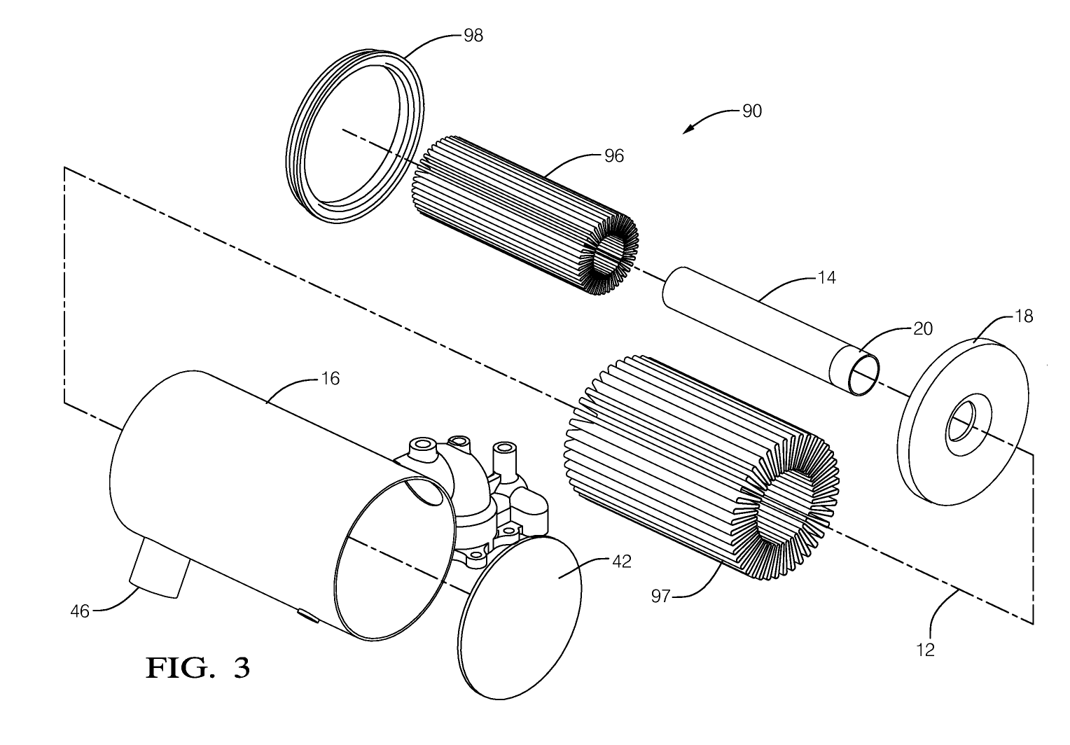

Referring to FIG. 1, FIG. 2, and FIG. 3, the exemplary combustor assembly 90 preferably has a generally cylindrical form and includes a tubular inner combustor wall 14 and a tubular outer combustor wall 16, each disposed about the axis 12. The reformer assembly 10 also includes an annular combustor partition 18 located at a first end 20 of the inner combustor wall 14 and extending from the outer surface of the inner combustor wall 14 to the inner surface of the outer combustor wall 16. A combustor endcap 42 closes off an end of the outer combustor wall 16 such that a combustor chamber 44 is defined within the outer combustor wall 16 between the combustor endcap 42 and the combustor partition 18. A combustor output port 46 is defined by an opening in the outer combustor wall 16. The exemplary combustor assembly 90 also includes a combustor-to-reactor flange 98 disposed on the exterior surface of the outer combustor wall 16. The inner combustor wall 14, the outer combustor wall 16, the combustor partition 18, the combustor endcap 42, and the combustor-to-reactor flange 98 are each preferably made of metal. It will be appreciated that features depicted as discrete elements comprising the combustor assembly 90, such as the inner combustor wall 14, the outer combustor wall 16, the combustor partition 18, the combustor endcap 42, and the combustor-to-reactor flange 98, may be further integrated with each other, or alternatively may be further divided into other combinations of components, without departing from the scope of the invention.

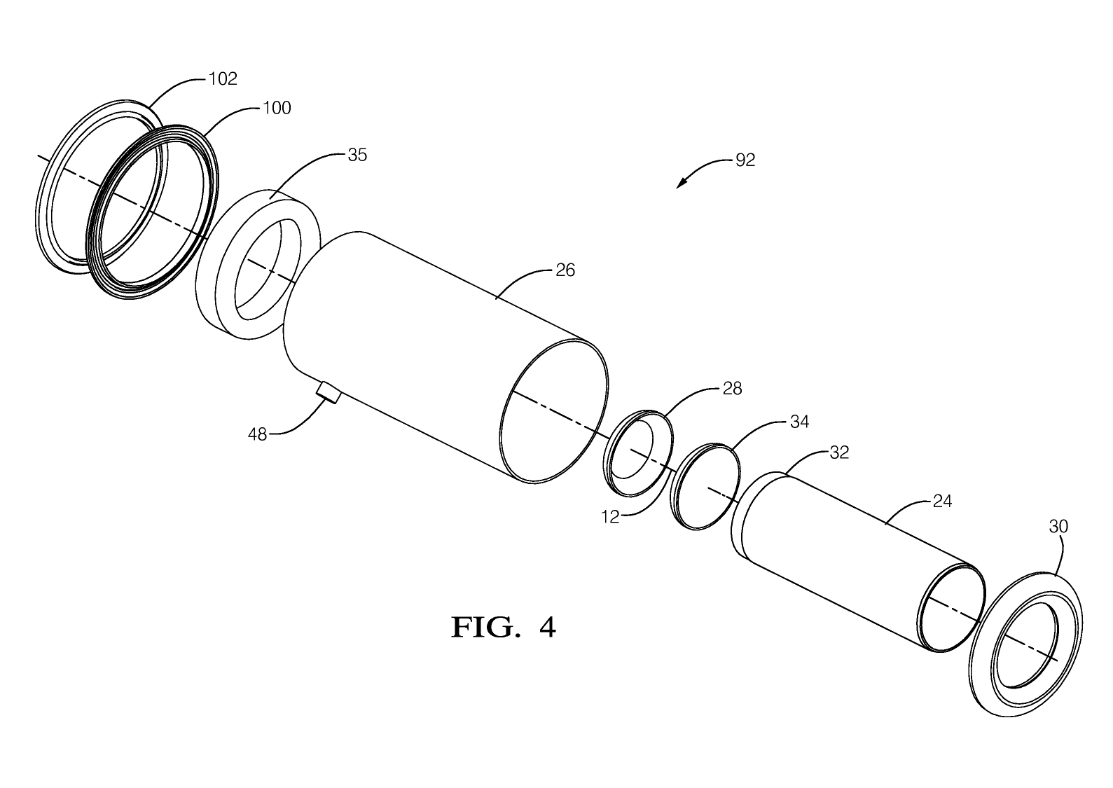

Referring to FIG. 1, FIG. 2, and FIG. 4, the exemplary reactor assembly 92 comprises a tubular inner reactor wall 24 disposed about the axis 12 and a tubular outer reactor wall 26 coaxial with the inner reactor wall 24. A first reactor endcap portion 28 closes off a first end 32 of the inner reactor wall 24, and an annular second reactor endcap portion 30 fluidtightly couples the inner reactor wall 24 to the outer reactor wall 26. A thermal break 34 may be disposed within the first reactor endcap portion 28. The thermal break 34 may be made of, for example only, a ceramic material. An annular thermal barrier 35 may be disposed within the end of the outer reactor wall 26 that is proximal to the FDU assembly 94. The function of thermal break 34 and thermal barrier 35 will be discussed in more detail later. A reactor output port 48 is defined by an opening in the outer reactor wall 26. The exemplary reactor assembly 92 also comprises a reactor-to-combustor flange 100 and a reactor-to-FDU flange 102, both of which are disposed on the exterior surface of the outer reactor wall 26. The inner reactor wall 24, the outer reactor wall 26, the first reactor endcap portion 28, the annular second reactor endcap portion 30, the reactor-to-combustor flange 100, and the reactor-to-FDU flange 102 are each preferably made of metal. It will be appreciated that features depicted as discrete elements comprising the reactor assembly 92, such as the inner reactor wall 24, the outer reactor wall 26, the first reactor endcap portion 28, the annular second reactor endcap portion 30, the reactor-to-combustor flange 100, and the reactor-to-FDU flange 102, may be further integrated with each other, or alternatively may be further divided into other combinations of components, without departing from the scope of the invention.

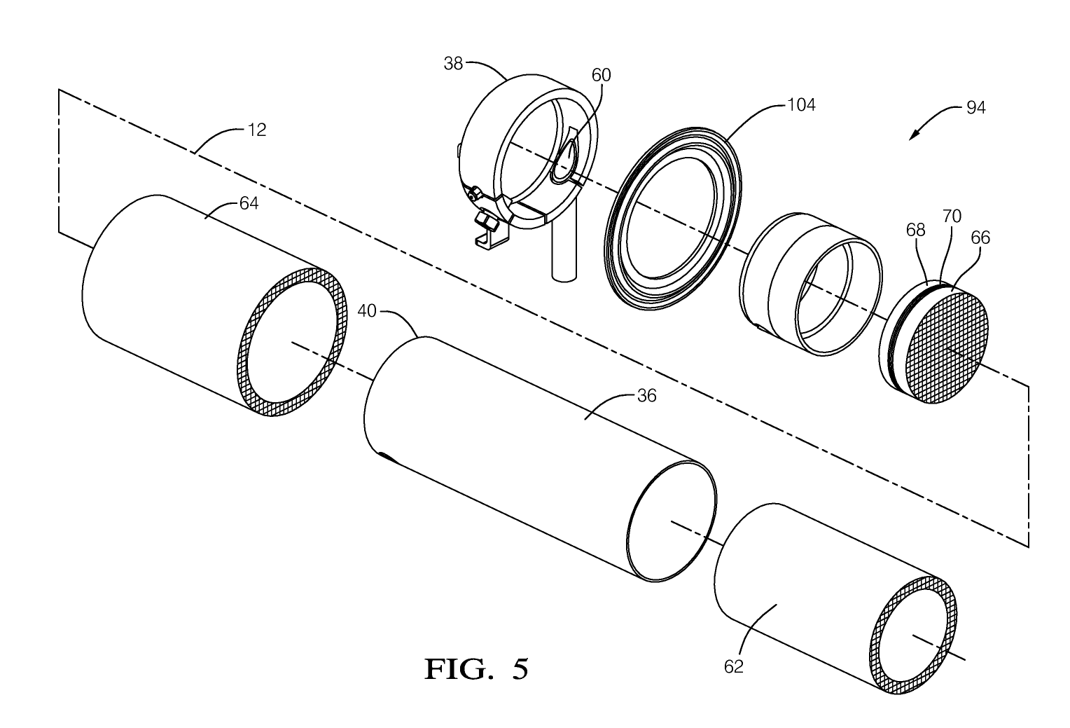

Referring to FIG. 1, FIG. 2, and FIG. 5, the FDU assembly 94 comprises a tubular FDU wall 36 and a FDU endcap portion 38 that fluidtightly closes off a first end 40 of the FDU wall 36. A FDU inlet port 60 is defined by an opening in the FDU endcap portion 38 or in the FDU wall 36. The FDU inlet port 60 is the point of entry for a fuel delivery chamber 61 that is located within FDU wall 36 at the first end 40. The FDU assembly 94 is shown bearing an inner catalyst substrate 62 disposed within the FDU wall 36, an outer catalyst substrate 64 disposed along the exterior of the FDU wall 36 and downstream of inner catalyst substrate 62, and a frontal catalyst substrate 66 disposed within the FDU wall 36 and upstream of the inner catalyst substrate 62. As shown, the outer catalyst substrate 64 radially surrounds the inner catalyst substrate 62 and a spaced is proved between the outer catalyst substrate 64 and the inner catalyst substrate 62. Also as shown, a space is provided between the inner catalyst substrate 62 and the frontal catalyst substrate 66. An arrestor 68 may be disposed along the interior of FDU wall 36 and upstream of frontal catalyst substrate 66. In use, the arrestor 68 may impede communication of thermal energy, including flames, from the frontal catalyst substrate 66 and/or the inner catalyst substrate 62 from being communicated to the fuel delivery chamber 61. The arrestor 68 may be separated from frontal catalyst substrate 66 by a radiation barrier 70 which may be, for example only, one or more layers of a ceramic cloth. In use, the radiation barrier 70 may further impede thermal energy from the frontal catalyst substrate 66 and/or the inner catalyst substrate 62 from being communicated to the fuel delivery chamber 61. In use, the thermal barrier 35 may impede thermal energy from the fourth annular flow channel 88 from being communicated to the fuel delivery chamber 61. Also in use, the thermal break 34 may impede thermal energy from the first medium flow path 50 from being communicated to the frontal catalyst substrate 66 and the fuel delivery chamber 61.

The inner catalyst substrate 62 supports a first catalyst disposed on the surface of inner catalyst substrate 62 and has sufficient porosity to allow fluid flow therethrough. The outer catalyst substrate 64 supports a second catalyst disposed on the surface of outer catalyst substrate 64 and has sufficient porosity to allow fluid flow therethrough. The frontal catalyst substrate 66 supports a third catalyst disposed on the surface of the outer catalyst substrate 64 and has sufficient porosity to allow fluid flow therethrough. The exemplary FDU assembly 94 further comprises a FDU-to-reactor flange 104 disposed on the exterior surface of the FDU wall 36. The FDU wall 36, the FDU endcap portion 38, and the FDU-to-reactor flange 104 are each preferably made of metal. It will be appreciated that features depicted as discrete elements of the FDU, such as the FDU wall 36, the FDU endcap portion 38, and the FDU-to-reactor flange 104, may be further integrated with each other, or alternatively may be further divided into other combinations of components, without departing from the scope of the invention.

In an advantageous embodiment, components of the combustor assembly 90 as shown in FIG. 3 may be assembled to each other using a suitable joining technique such as brazing. Similarly, components of the reactor assembly 92 as shown in FIG. 4 may be assembled to one another using a suitable joining technique such as brazing. Components of the FDU assembly 94 may be likewise assembled to one another using a suitable joining technique such as brazing.

Referring to FIG. 1 and FIG. 2, the reformer assembly 10 may be assembled by axially inserting the combustor assembly 90 over the reactor assembly 92 until the combustor-to-reactor flange 98 is adjacent to the reactor-to-combustor flange 100, and inserting the FDU assembly 94 with inner catalyst substrate 62 and outer catalyst substrate 64 into the reactor assembly 92 until the FDU-to-reactor flange 104 is adjacent to the reactor-to-FDU flange 102. A suitable joining technique such as brazing may be used to sealingly attach the combustor-to-reactor flange 98 to the reactor-to-combustor flange 100, as well as to sealingly attach the reactor-to-FDU flange 102 to the FDU-to-reactor flange 104.

Operation of the exemplary reformer assembly 10 shown in FIG. 1 through FIG. 5 will now be described. The reformer assembly 10 defines two distinct flow paths that are kept isolated from each other. The first of these is a heated medium flow path, which is indicated by the first medium flow path arrows 50. A heated medium may be generated by combusting a fuel in the combustor chamber 44, or alternatively a heated medium may be generated external to the reformer assembly 10 and introduced into the combustor chamber 44. The heated medium travels through the interior of the inner combustor wall 14 in a direction from the first end 20 of the inner combustor wall 14 toward the second end 22 of the inner combustor wall 14. Upon exiting the second end 22 of the inner combustor wall 14, the heated medium flows radially outward, reverses direction axially, and flows in the first annular flow channel 82 defined between the inner combustor wall 14 and the inner reactor wall 24. In the vicinity of the combustor partition 18, the heated medium again flows radially outwardly, reverses direction axially, and flows in the second annular flow channel 84 defined between the outer reactor wall 26 and the outer combustor wall 16 until reaching the combustor output port 46.

The second distinct flow path depicted in FIG. 1 is a reforming flow path, which is indicated by the second medium flow path arrows 52. A feedstream of chemical constituents to be catalytically reformed enters the fuel delivery chamber 61 through the FDU inlet port 60. The feedstream may include air, fuel, and/or recycled gas from a solid oxide fuel cell (recycled gas may include, for example only H₂, H₂O, CO, CO₂, and N₂). From the fuel delivery chamber 61, the feedstream passes through the arrestor 68 and the radiation barrier 70. Since the arrestor 68 and the radiation barrier 70 do not contain a catalyst, the feedstream may pass through the arrestor 68 and the radiation barrier 70 substantially unreacted.

After passing through the arrestor 68 and the radiation barrier 70, the feedstream passes through the frontal catalyst substrate 66. The catalyst supported by the frontal catalyst substrate 66 may produce an exothermic reaction in the area of the frontal catalyst substrate 66 which is proximal to the arrestor 68 and an endothermic reaction in the area of the frontal catalyst substrate 66 which is proximal to inner catalyst substrate 62. The products exiting the frontal catalyst substrate 66 may include H₂, H₂O, CO, CO₂, N₂, and unreacted fuel.

The products exiting the frontal catalyst substrate 66 are then passed into inner catalyst substrate 62 in the second axial direction 8. The catalyst supported by the inner catalyst substrate 62 may produce an endothermic reaction. In order to support the endothermic reaction within inner catalyst substrate 62, heat may be transferred to inner catalyst substrate 62 from the medium in the first medium flow path 50. In order to improve heat transfer from the medium in the first medium flow path 50 to the inner catalyst substrate 62, features may be included to augment the heat transfer coefficient between the first medium flow path 50 and the second medium flow path 52. For example, a first heat exchange 96 may be included on the exterior of the inner combustor wall 14 where the first heat exchange 96 will be exposed to the first annular flow channel 82 to promote heat transfer from the first annular flow channel 82 to the inner reactor wall 24. As shown, the inner catalyst substrate 62 radially surrounds the first heat exchanger 96. In addition to the first heat exchanger 96, a second heat exchanger may be included on the interior of outer combustor wall 16 where the second heat exchanger will be exposed to the second annular flow channel 84 to promote heat transfer from the second annular flow channel 84 to the outer reactor wall 26. Other heat transfer augmentation features may be defined in or disposed on the inner reactor wall 24 and/or the outer reactor wall 26 which separate the first medium flow path 50 from the inner catalyst substrate 62. Such heat transfer augmentation features may include foams, corrugations, dimples, and/or pedestals. The products exiting inner catalyst substrate 62 may include H₂, H₂O, CO, CO₂, N₂, and small amounts of unreacted fuel (between about 0 to 5%).

The products exiting inner catalyst substrate 62 are then passed into outer catalyst substrate 64 in the first axial direction 6. The catalyst supported by the outer catalyst substrate 64 may produce an isothermal reaction which results in products exiting outer catalyst substrate 64 that may include H₂, H₂O, CO, CO₂, N₂ and only insignificant amounts of anything else. The products exiting outer catalyst substrate 64, i.e. reformate, are then passed out through the reactor output port 48.

The inner reactor wall 24, the outer reactor wall 26, the first reactor endcap portion 28, and the annular second reactor endcap portion 30 are sealed to each other to provide hermetic isolation between the first medium flow path 50 and the second medium flow path 52. The inner reactor wall 24, the outer reactor wall 26, the first reactor endcap portion 28, and the annular second reactor endcap portion 30 are each preferably made from a thermally conductive material to facilitate heat transfer between the first medium flow path 50 and the second medium flow path 52.

In operation, a reformer assembly will be subjected to high temperature excursions as well as high differential temperatures within the assembly. As a result, differential thermal expansion of components within a reformer assembly may be considerable. The reformer assembly 10 shown in FIG. 1 through FIG. 5 minimizes thermally induced stresses by joining components to each other at one axial location. This allows differential axial growth of components to occur, such as due to different component temperatures or differences in temperature coefficient of expansion between component materials, without imparting axial stresses on the components. For example, the combustor assembly 90 is mechanically coupled to the reactor assembly 92 only at the interface between the combustor-to-reactor flange 98 and the reactor-to-combustor flange 100. The inner reactor wall 24 and the outer reactor wall 26 may grow and shrink axially relative to the outer combustor wall 16 and/or the inner combustor wall 14 without being constrained by the combustor components other than at the interface between the combustor-to-reactor flange 98 and the reactor-to-combustor flange 100.

Similarly, the reactor assembly 92 is mechanically coupled to the FDU assembly 94 only at the interface between the reactor-to-FDU flange 102 and the FDU-to-reactor flange 104. The FDU wall 36 may grow and shrink axially relative to the inner reactor wall 24 and the outer reactor wall 26 without being constrained by the reactor components other than at the interface between the reactor-to-FDU flange 102 and the FDU-to-reactor flange 104.

While outer catalyst substrate 64 supporting the second catalyst has been illustrated as being positioned within outer reactor wall 26, it should now be understood that outer catalyst substrate 64 may alternatively be located within a separate housing that is located downstream of reactor output port 48.

While this invention has been described in terms of the preferred embodiments thereof, it is not intended to be so limited, but rather only to the extent set forth in the claims that follow.

We claim:

1. A catalytic reformer assembly comprising:
a heated medium flow path for a first medium;
a reforming flow path for a second medium;
a first catalyst substrate supporting a first catalyst and located within said reforming flow path; and
a first heat exchanger disposed within said heated medium flow path for transferring heat from said heated medium flow path to said first catalyst substrate.

2. A catalytic reformer assembly as in claim 1 further comprising a second catalyst substrate supporting a second catalyst downstream of said first catalyst substrate.

3. A catalytic reformer assembly as in claim 2 wherein said second catalyst substrate is located within said reforming flow path.

4. A catalytic reformer assembly as in claim 3 further comprising a third catalyst substrate supporting a third catalyst and located within said reforming flow path upstream of said first catalyst substrate.

5. A catalytic reformer assembly as in claim 3 further comprising an arrestor within said reforming flow path upstream of said first catalyst substrate for impeding communication of thermal energy from said first catalyst substrate upstream of said arrestor.

6. A catalytic reformer assembly as in claim 5 further comprising a third catalyst substrate supporting a third catalyst and located within said reforming flow path upstream of said first catalyst substrate and downstream of said arrestor.

7. A catalytic reformer assembly as in claim 6 wherein a space is provided in said reforming flow path upstream of said first catalyst substrate and downstream of said third catalyst substrate.

8. A catalytic reformer assembly as in claim 6 wherein a radiation barrier is disposed between said arrestor and said third catalyst substrate.

9. A catalytic reformer assembly as in claim 8 wherein said radiation barrier is a ceramic cloth.

10. A catalytic reformer assembly as in claim 3 further comprising:
a fuel delivery chamber in fluid communication with said reforming flow path and upstream of said first catalyst substrate; and
a thermal break disposed between said fuel delivery chamber and said heated medium flow path for impeding communication of thermal energy from said heated medium flow path to said fuel delivery chamber.

11. A catalytic reformer assembly as in claim 3 wherein a space in said reforming flow path is provided upstream of said second catalyst substrate and downstream of said first catalyst substrate.

12. A catalytic reformer assembly as in claim 3 wherein said second catalyst substrate radially surrounds said first catalyst substrate.

13. A catalytic reformer assembly as in claim 3 wherein said first catalyst substrate radially surrounds said first heat exchanger.

14. A catalytic reformer assembly as in claim 13 wherein said second catalyst substrate radially surrounds said first catalyst substrate.

15. A catalytic reformer assembly as in claim 3 further comprising a second heat exchanger disposed within said heated medium flow path for transferring heat from said heated medium flow path to said second catalyst substrate.

16. A catalytic reformer assembly as in claim 15 wherein in said second heat exchanger is disposed downstream of said first heat exchanger.

17. A catalytic reformer assembly as in claim 15 wherein said second heat exchanger radially surrounds said first heat exchanger.

18. A catalytic reformer assembly as in claim 17 wherein said second heat exchanger radially surrounds said second catalyst substrate.

19. A catalytic reformer assembly as in claim 3 further comprising:
a fuel delivery chamber in fluid communication with said reforming flow path and upstream of said first catalyst substrate; and
a thermal barrier in said reforming flow path for impeding communication of thermal energy from said reforming flow path to said fuel delivery chamber.

20. A catalytic reformer assembly as in claim 19 wherein said thermal barrier is downstream of said second catalyst substrate.

21. A catalytic reformer assembly as in claim 19 wherein said thermal barrier is annular in shape.
